(19) United States
(12) Patent Application Publication
(10) Pub. No.: US 2018/0051234 A1
(43) Pub. Date: Feb. 22, 2018

(54) CLEANING COMPOSITION

(71) Applicant: The Procter & Gamble Company, Cincinnati, OH (US)

(72) Inventors: Patrick Firmin August DELPLANCKE, Steenhuize-Wijnhuize (BE); Phillip Kyle VINSON, Fairfield, OH (US); Neil Thomas FAIRWEATHER, Liberty Township, OH (US); Scott Leroy CRON, Liberty Township, OH (US); Jamila TAJMAMET, Brussels (BE); Prakash J. MADHAV, Maineville, OH (US); David Thomas STANTON, Hamilton, OH (US)

(21) Appl. No.: 15/678,718

(22) Filed: Aug. 16, 2017

(30) Foreign Application Priority Data
Aug. 17, 2016 (EP) 16184415.4
Mar. 30, 2017 (EP) 17163890.1

(51) Int. Cl. C11D 3/30; C11D 1/94

(52) U.S. Cl. CPC C11D 3/30; C11D 1/29; C11D 1/94

(57) ABSTRACT

A hand dishwashing cleaning composition including a surfactant system and an amine of Formula (I):

R1-N-(R2)(CH2CHOH(CH2O)nR3) (I)

wherein R1 and R2 are independently selected from hydrogen, cyclic or acyclic, linear or branched C1 to C10 alkyl, C1 to C10 hydroxyalkyl, polyhydroxyhydrocarbyl and polyalkoxy of formula (R4-O)xH with R4 being C1-C4 and x=1 to 15; n is 0 or 1, preferably 1; and R3 is a C6 to C30 hydrocarbyl.

### FIELD OF THE INVENTION

The present invention is in the field of hand dishwashing. In particular, it relates to a hand dishwashing cleaning composition, more in particular to a composition comprising an amine The composition provides good cleaning, in particular good grease removal. The composition also provides good and stable suds even when exposed to acidifying soils.

### BACKGROUND OF THE INVENTION

Hand dishwashing trends are changing. Traditionally, the washing up has been done in a sink full of water with the cleaning composition diluted in it. Nowadays, the trend is to wash under running water using a cleaning implement, such as a sponge. The cleaning composition is dosed onto the cleaning implement before or after the implement is wetted, a soiled item is then wiped and subsequently rinsed under running water. This new way of hand dishwashing, sometimes referred to as direct application, places the cleaning composition in a new environment that needs to be taken into account for the design of the composition. With the new preference of using direct application, there is a need to provide a cleaning composition that performs well under the new usage conditions.

Hand dishwashing detergent compositions should not only provide good soil and grease removal but also good and durable suds.

Users usually see suds as an indicator of the performance of a cleaning composition. Moreover, the user of a hand dishwashing cleaning composition also uses the sudsing profile and the appearance of the foam (density, whiteness) as an indicator that the wash solution or cleaning implement still contains active detergent ingredients. The user usually doses the dishwashing detergent depending on the foam ability and adds more detergent when the suds subsides or when the foam does not look strong enough. Thus, a wash liquor comprising a dishwashing detergent composition that generates little foam would tend to be replaced by the user more frequently than it is necessary. Hand dishwashing detergent compositions need to exhibit good foam height and appearance as well as good foam generation during the initial mixing of the detergent with water and good lasting foam during the entire manual dishwashing operation.

Some of the typical soils present in dishware have acidic nature, for example fatty soils, and consequently lower the pH of the wash solution once the soiled dishware is contacted with the solution. The lowering of the pH of the wash solution can negatively impact the foaming potential of a detergent composition.

There is a need to provide hand dishwashing compositions with improved foam stability even in presence of acidifying soils especially at lower wash pHs, and possessing improved foam properties while at the same time providing good cleaning, in particular cleaning of greasy soils.

### SUMMARY OF THE INVENTION

According to the first aspect of the invention, there is provided a hand dishwashing cleaning composition, preferably in liquid form. The composition comprises a surfactant system and an amine The composition provides excellent grease removal, especially under direct application conditions. The composition also provides stable and long lasting suds even in the presence of acidifying soils such as greasy soils.

The amine has the following Formula (I):

R1-N-(R2)(CH2CHOH(CH2O)nR3) (I)
wherein
R1 and R2 are independently selected from hydrogen, cyclic or acyclic, linear or branched C1 to C10 alkyl, C1 to C10 hydroxyalkyl, polyhydroxyhydrocarbyl and polyalkoxy of formula (R4-O)xH with R4 being C1-C4 and x=1 to 15, preferably x=1 to 5, more preferably x=1;
n is 0 or 1, preferably 1; and
R3 is a C6 to C30 hydrocarbyl, preferably C6 to C30 alkyl, hydroxyalkyl, alkoxyalkyl, cycloalkyl, aralkyl or alkenyl.

The surfactant system of the composition of the invention preferably comprises an anionic surfactant and optionally a co-surfactant selected from the group consisting of amphoteric surfactant, zwitterionic surfactant and mixtures thereof. The composition can further comprise a non-ionic surfactant.

The anionic surfactant can be any anionic cleaning surfactant, especially preferred anionic surfactants are selected from the group consisting of alkyl sulfate, alkyl alkoxy sulfate, alkyl benzene sulfonate, paraffin sulfonate and mixtures thereof. Preferred anionic surfactants are selected from alkyl sulfate, alkyl alkoxy sulfate and mixtures thereof, a preferred alkyl alkoxy sulfate is alkyl ethoxy sulfate. Preferred anionic surfactant for use herein is a mixture of alkyl sulfate and alkyl ethoxy sulfate.

Extremely useful surfactant systems for use herein include those comprising anionic surfactants, in combination with amine oxide, especially alkyl dimethyl amine oxides, and/or betaine surfactants.

Another preferred surfactant system for use herein is an anionic and amphoteric/zwitterionic system in which the amphoteric to zwitterionic weight ratio is preferably from about 2:1 to about 1:2. In particular a system in which the amphoteric surfactant is an amine oxide surfactant and the zwitteronic surfactant is a betaine and the weight ratio of the amine oxide to the betaine is about 1:1.

Also preferred for use herein are surfactant systems further comprising non-ionic surfactants. Especially preferred nonionic surfactants are alkyl alkoxylated nonionic surfactants, especially alkyl ethoxylated surfactants.

Especially preferred surfactant systems for the composition of the invention comprise an anionic surfactant preferably selected from the group consisting of alkyl sulfate, alkyl alkoxy sulfate and mixtures thereof, more preferably an alkyl alkoxylated sulfate, and an amphoteric surfactant, preferably an amino oxide surfactant and optionally a non-ionic surfactant. In summary, the most preferred surfactant system for use herein comprises an alkyl alkoxylated sulfate surfactant, amine oxide and optionally non-ionic surfactant, especially an alkyl ethoxylated sulfate surfactant, alkyl dimethyl amine oxide and an alkyl ethoxylate nonionic surfactant.

The composition of the invention can further comprise a salt of a divalent cation. In particular, a salt of magnesium. Magnesium cations might work in combination with the amine by strengthening and broadening the grease cleaning profile of the composition.

The composition of the invention can further comprise a chelant. Chelants can act in combination with the amine of the invention to provide improved grease cleaning. Preferred chelants for use herein are aminophosphonate and aminocarboxylated chelants in particular aminocarboxylated chelants such as methyl-glycine-diacetic acid (MGDA) and glutamic-N,N-diacetic acid (GLDA).

According to the second aspect of the invention there is provided a method of manually washing dishware using the composition of the invention in neat form (direct application). The composition of the invention can also be used in diluted form (full sink), however greater benefits in terms of grease cleaning are obtained when the composition is directly applied on the soiled surface or on a cleaning implement, such as sponge, to be used to clean the soiled surface. There is also provided the use of the composition of the invention for the removal of greasy soils in manual dishwashing and the use of the composition to stabilize suds in the presence of acidifying soils such as greasy soils. It has been discovered that acidifying soils with a cleaning composition outside the scope of the present invention can lower the pH of the wash solution to below 7, negatively impacting suds volume accordingly. We surprisingly found that addition of an amine according to the invention helps counteract the observed suds impact in the presence of acidifying soils.

According to another aspect of the invention there is provided a wash solution for hand dishwashing comprising acidifying soil and a cleaning composition, wherein the cleaning composition comprises an amine of Formula (I):

R1-N-(R2)(CH2CHOH(CH2O)nR3) (I)

wherein R1 and R2 are independently selected from hydrogen, cyclic or acyclic, linear or branched C1 to C10 alkyl, C1 to C10 hydroxyalkyl, polyhydroxyhydrocarbyl and polyalkoxy of formula (R4-O)xH with R4 being C1-C4 and x=1 to 15; n is 0 or 1, preferably 1; and R3 is a C6 to C30 hydrocarbyl; and a surfactant system comprising an anionic surfactant preferably selected of sulfate or sulfonate anionic surfactants, preferably selected from the group consisting of alkyl sulfate, alkyl alkoxy sulfate and mixtures thereof and wherein the alkyl alkoxy sulfate is preferably an alkyl ethoxy sulphate; and a co-surfactant selected from the group consisting of amphoteric surfactant, zwitterionic surfactant and mixtures thereof; wherein the pH of the wash solution is between 4 and 9. Preferably, the pH of the wash solution is between 4 and 8, more preferably between 5 and 7.

The elements of the composition of the invention described in connexion with the first aspect of the invention apply mutatis mutandis to the other aspects of the invention.

### DETAILED DESCRIPTION OF THE INVENTION

The present invention envisages a cleaning composition, preferably a hand dishwashing cleaning composition, comprising a surfactant system and a specific amine The composition of the invention provides very good grease removal, in particular very good uncooked grease removal and long lasting suds. The invention also envisages a method of hand dishwashing and use of the composition for the removal of greasy soils and suds longevity especially in presence of acidifying soils such as greasy soils.

The Cleaning Composition

The cleaning composition is a hand dishwashing cleaning composition, preferably in liquid form. It typically contains from 30% to 95%, preferably from 40% to 90%, more preferably from 50% to 85% by weight of a liquid carrier in which the other essential and optional components are dissolved, dispersed or suspended. One preferred component of the liquid carrier is water.

Preferably the pH of the composition is from about 6 to about 12, more preferably from about 7 to about 11 and most preferably from about 7.5 to about 10, as measured at 25° C. and 10% aqueous concentration in distilled water. The cleaning amine of the invention performs better at a pH of from 7.5 to 10. The pH of the composition can be adjusted using pH modifying ingredients known in the art.

Amine

Preferably, the composition of the invention includes from about 0.1% to about 15% by weight of the composition of the amine. When the surfactant system is substantially free of co-surfactant selected from the group consisting of amphoteric, zwitterionic surfactants and mixtures thereof, i.e., less than 1% by weight of the composition, the composition of the invention preferably comprises from about 0.2% to about 10% by weight of the composition, of the amine When the surfactant system comprises a co-surfactant selected from the group consisting of amphoteric, zwitterionic surfactants and mixtures thereof, the composition of the invention preferably comprises from 0.2% to about 5%, by weight of the composition, of the amine Although the amine of Formula (I) might act as a co-surfactant is not considered as a “co-surfactant selected from the group consisting of amphoteric, zwitterionic surfactants and mixtures thereof” within the meaning of the invention.

The composition of the invention comprises an amine compound according to Formula (I):

R1-N-(R2)(CH2CHOH(CH2O)nR3) (I)

wherein
R1 and R2 are independently selected from hydrogen, cyclic or acyclic, linear or branched C1 to C10 alkyl, C1 to C10 hydroxyalkyl, polyhydroxyhydrocarbyl and polyalkoxy having the formula (R4-O)xH with R4 being C1-C4 and x=1 to 15, preferably x=1 to 5, more preferably x=1;
n is 0 or 1, preferably 1; and
R3 is a C6 to C30 hydrocarbyl, preferably C6 to C30 alkyl, hydroxyalkyl, alkoxyalkyl, cycloalkyl, aralkyl or alkenyl.

A “polyhydroxyhydrocarbyl” is a hydrocarbyl with two or more hydroxyl (—OH) groups. A “hydrocarbyl” is a univalent group formed by removing a hydrogen atom from a hydrocarbon, e.g. ethyl, phenyl.

When R1 is a polyhydroxyhydrocarbyl, R1 is an acyclic or cyclic polyhydroxyhydrocarbyl, preferably a linear polyhydroxyhydrocarbyl. Preferably R1 is a linear C3 to C8 chain with at least two hydroxyl groups, preferably a C4 to C7 chain with at least three hydroxyl groups directly bonded to the carbon atoms of the chain. R1 can include substituents, in particular, alkoxy groups e.g. by etherification of further hydroxyl groups or further polyhydroxyhydrocarbyl, e.g. polyhydroxy alkyl, group(s). R1 preferably includes at least three free hydroxyl groups including such hydroxyl groups on substituents of the basic carbon chain. Alternatively R1 can be selected from ring structures comprising an internal ether link, the ring comprising at least two or more hydroxyl groups, most preferably the hydroxyl groups are on a carbon atom not connected to the nitrogen in Formula (I). R1 can be an open chain tetratol, pentitol, hexitol or heptitol group or an anhydro e.g. cycloether anhydro derivative of such a group. Preferably R1 is the residue of, or a residue derived from a sugar, particularly a monosaccharide such as glucose, xylose, fructose or sorbitol; a disaccharide such as maltose or sucrose; or a higher oligosaccharide. Preferably, R1 is derived from a sugar of the group consisting of glucose, xylose, maltose and mixtures thereof.

Preferred R1 groups are derived from glycoses and are of the formula:

—CH2-(CHOH)4-CH2OH,

e.g. corresponding to residues from glucose, mannose or galactose. It is specially preferred when R1 is derived from glucose. In this case the group —NR1 is of the formula:

—N—CH2 (CHOH)4-CH2OH

and the group is conveniently called a glycamine group. Most preferably the group R1 will be derived from glucose and the corresponding amines may be called glucamines (as they will usually be made from glucose).

When R1 is a C1 to C10 alkyl, it is preferably an alkyl comprising from 1 to 5, more preferably from 1 to 4, even more preferably from 1 to 2 carbon atoms. Most preferably when R1 is not a polyhydroxyhydrocarbyl, it is hydrogen or methyl.

Most preferably R1 is a polyhydroxyhydrocarbyl.

When R1 is a polyhydroxyhydrocarbyl, R2 is preferably selected from the group consisting of hydrogen and C1 to C10 alkyl. R2 is preferably hydrogen or an alkyl group comprising from 1 to 5, more preferably from 1 to 4 and even more preferably from 1 to 2 carbon atoms. Most preferably R2 is hydrogen or methyl.

When R1 is not a polyhydroxyhydrocarbyl, R1 and R2 are preferably independently selected from hydrogen or an alkyl group comprising from 1 to 5 preferably from 1 to 4 and even more preferably from 1 to 2 carbon atoms. Most preferably R1 and R2 are independently selected from hydrogen or methyl.

R3 is a hydrocarbyl, preferably selected from C6 to C30 alkyl, hydroxyalkyl, alkoxyalkyl, cycloalkyl, aralkyl or alkenyl groups, preferably the alkyl group comprises from 6 to 30, preferably from 7 to 20, more preferably from 8 to 15, even more preferably from 8 to 12 and most preferably from 8 to 10 carbon atoms. The alkyl group can be linear or branched, preferably C1 to C4 branching, more preferably C1 to C3 branching on the 2- or 3-position, preferably 2-position. R3 can also be a substituted alkyl group e.g. a hydroxy or alkoxy substituted alkyl group, particularly a C6 to C30 alkyl group which is hydroxy substituted. The additional hydroxyl group or oxygen atom may provide a modest increase in water solubility. R3 can also be an aralkyl group, particularly a C7 to C12 aralkyl group, such as a benzyl group. Preferably R2 is selected from hydrogen and methyl and R3 from octyl and decyl. Most preferably R1 is derived from glucose, R2 is selected from hydrogen and methyl and R3 from octyl and decyl.

Preferred amines for use herein are those in which n is 1, R1 is glucose as such forming a glucamine compound, R2 is methyl and R3 is hexyl, octyl or decyl.

When R3 is octyl, it is preferably selected from n-octyl, and 2-ethylhexyl. When R3 is decyl, it is preferably selected from n-decyl and 2-propylheptyl.

Other preferred amines for use herein are those in which n is 1, R1 and R2 are methyl and R3 is hexyl, octyl or decyl. When R3 is octyl, it is preferably selected from n-octyl and 2-ethylhexyl. When R3 is decyl, it is preferably selected from n-decyl and 2-propylheptyl.

Mixtures of different amines can have benefits in terms of processing, solubility and performance.

The amine of the invention allows the replacement of part of the co-surfactant of the surfactant system without losing or even improving grease cleaning performance.

Surfactant System

The cleaning composition comprises from about 1% to about 60%, preferably from about 5% to about 50% more preferably from about 8% to about 40% by weight thereof of a surfactant system. The surfactant system preferably comprises an anionic surfactant, more preferably an anionic surfactant selected from the group consisting of alkyl sulfate, alkyl alkoxy surfate, especially alkyl ethoxy sulfate, alkyl benzene sulfonate, paraffin sulfonate and mixtures thereof. The system preferably comprises an amphoteric, and/or zwitterionic surfactant and optionally a non-ionic surfactant.

Alkyl sulfates are preferred for use herein, especially alkyl ethoxy sulfates; more preferably a combination of alkyl sulfates and alkyl ethoxy sulfates with a combined average ethoxylation degree of less than 5, preferably less than 3, more preferably less than 2 and more than 0.5 and an average level of branching of from about 5% to about 40%.

The composition of the invention preferably comprises an amphoteric and/or zwitterionic surfactant, preferably the amphoteric surfactant comprises an amine oxide, preferably an alkyl dimethyl amine oxide, and the zwitteronic surfactant comprises a betaine surfactant.

The most preferred surfactant system for the detergent composition of the present invention comprise from 1% to 40%, preferably 6% to 35%, more preferably 8% to 30% weight of the total composition of an anionic surfactant, preferably an alkyl alkoxy sulfate surfactant, more preferably an alkyl ethoxy sulfate, combined with 0.5% to 15%, preferably from 1% to 12%, more preferably from 2% to 10% by weight of the composition of amphoteric and/or zwitterionic surfactant, more preferably an amphoteric and even more preferably an amine oxide surfactant, especially and alkyl dimethyl amine oxide. Preferably the composition further comprises a nonionic surfactant, especially an alcohol alkoxylate in particular and alcohol ethoxylate nonionic surfactant. It has been found that such surfactant system in combination with the amine of the invention provides excellent grease cleaning and good finish of the washed items, as well as improved suds duration especially in presence of acidifying soils such as greasy soils.

Anionic Surfactant

Anionic surfactants include, but are not limited to, those surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. Usually, the hydrophobic group will comprise a C 8-C 22 alkyl, or acyl group. Such surfactants are employed in the form of water-soluble salts and the salt-forming cation usually is selected from sodium, potassium, ammonium, magnesium and mono-, di- or tri-C alkanolammonium, with the sodium, cation being the usual one chosen.

The anionic surfactant can be a single surfactant but usually it is a mixture of anionic surfactants. Preferably the anionic surfactant comprises a sulfate surfactant, more preferably a sulfate surfactant selected from the group consisting of alkyl sulfate, alkyl alkoxy sulfate and mixtures thereof. Preferred alkyl alkoxy sulfates for use herein are alkyl ethoxy sulfates.

Sulfated Anionic Surfactant

Preferably the sulfated anionic surfactant is alkoxylated, more preferably, an alkoxylated branched sulfated anionic surfactant having an alkoxylation degree of from about 0.2 to about 4, even more preferably from about 0.3 to about 3, even more preferably from about 0.4 to about 1.5 and especially from about 0.4 to about 1. Preferably, the alkoxy group is ethoxy. When the sulfated anionic surfactant is a mixture of sulfated anionic surfactants, the alkoxylation degree is the weight average alkoxylation degree of all the components of the mixture (weight average alkoxylation degree). In the weight average alkoxylation degree calculation the weight of sulfated anionic surfactant components not having alkoxylated groups should also be included.

Weight average alkoxylation degree=(x1* alkoxylation degree of surfactant 1+x2 *alkoxylation degree of surfactant 2+ . . . )/(x1+x2+ . . . )

wherein x1, x2, . . . are the weights in grams of each sulfated anionic surfactant of the mixture and alkoxylation degree is the number of alkoxy groups in each sulfated anionic surfactant.

Preferably, the branching group is an alkyl. Typically, the alkyl is selected from methyl, ethyl, propyl, butyl, pentyl, cyclic alkyl groups and mixtures thereof. Single or multiple alkyl branches could be present on the main hydrocarbyl chain of the starting alcohol(s) used to produce the sulfated anionic surfactant used in the detergent of the invention. Most preferably the branched sulfated anionic surfactant is selected from alkyl sulfates, alkyl ethoxy sulfates, and mixtures thereof.

The branched sulfated anionic surfactant can be a single anionic surfactant or a mixture of anionic surfactants. In the case of a single surfactant the percentage of branching refers to the weight percentage of the hydrocarbyl chains that are branched in the original alcohol from which the surfactant is derived.

In the case of a surfactant mixture the percentage of branching is the weight average and it is defined according to the following formula:

Weight average of branching (%)=[x1*wt % branched alcohol 1 in alcohol 1+x2*wt % branched alcohol 2 in alcohol 2+ . . . )/(x1+x2+ . . . )]*100

wherein x1, x2, . . . are the weight in grams of each alcohol in the total alcohol mixture of the alcohols which were used as starting material for the anionic surfactant for the detergent of the invention. In the weight average branching degree calculation the weight of anionic surfactant components not having branched groups should also be included.

Suitable sulfate surfactants for use herein include water-soluble salts of C8-C18 alkyl or hydroxyalkyl, sulfate and/or ether sulfate. Suitable counterions include alkali metal cation or ammonium or substituted ammonium, but preferably sodium.

The sulfate surfactants may be selected from C8-C18 primary, branched chain and random alkyl sulfates (AS); C8-C18 secondary (2,3) alkyl sulfates; C8-C18 alkyl alkoxy sulfates (AExS) wherein preferably x is from 1-30 in which the alkoxy group could be selected from ethoxy, propoxy, butoxy or even higher alkoxy groups and mixtures thereof.

Alkyl sulfates and alkyl alkoxy sulfates are commercially available with a variety of chain lengths, ethoxylation and branching degrees. Commercially available sulfates include, those based on Neodol alcohols ex the Shell company, Lial-Isalchem and Safol ex the Sasol company, natural alcohols ex The Procter & Gamble Chemicals company.

Preferably, the anionic surfactant comprises at least 50%, more preferably at least 60% and especially at least 70% of a sulfate surfactant by weight of the anionic surfactant. Especially preferred detergents from a cleaning view point are those in which the anionic surfactant comprises more than 50%, more preferably at least 60% and especially at least 70% by weight thereof of sulfate surfactant and the sulfate surfactant is selected from the group consisting of alkyl sulfates, alkyl ethoxy sulfates and mixtures thereof. Even more preferred are those in which the anionic surfactant is an alkyl ethoxy sulfate with a degree of ethoxylation of from about 0.2 to about 3, more preferably from about 0.3 to about 2, even more preferably from about 0.4 to about 1.5, and especially from about 0.4 to about 1. They are also preferred anionic surfactant having a level of branching of from about 5% to about 40%, even more preferably from about 10% to 35% and especially from about 20% to 30%.

Sulphonate Surfactant

Suitable sulphonate surfactants for use herein include water-soluble salts of C8-C18 alkyl or hydroxyalkyl sulphonates, C11-C18 alkyl benzene sulphonates (LAS), modified alkylbenzene sulphonate (MLAS), methyl ester sulphonate (MES); and alpha-olefin sulphonate (AOS). Those also include the paraffin sulphonates may be monosulphonates and/or disulphonates, obtained by sulphonating paraffins of 10 to 20 carbon atoms. The sulfonate surfactant also includes the alkyl glyceryl sulphonate surfactants.

Non Ionic Surfactant

Nonionic surfactant, when present, is comprised in a typical amount of from 0.1% to 40%, preferably 0.2% to 20%, most preferably 0.5% to 10% by weight of the composition. Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 18 carbon atoms, preferably from 10 to 15 carbon atoms with from 2 to 18 moles, preferably 2 to 15, more preferably 5-12 of ethylene oxide per mole of alcohol. Highly preferred nonionic surfactants are the condensation products of guerbet alcohols with from 2 to 18 moles, preferably 2 to 15, more preferably 5-12 of ethylene oxide per mole of alcohol.

Other suitable non-ionic surfactants for use herein include fatty alcohol polyglycol ethers, alkylpolyglucosides and fatty acid glucamides.

Amphoteric Surfactant

Preferred amine oxides are alkyl dimethyl amine oxide or alkyl amido propyl dimethyl amine oxide, more preferably alkyl dimethyl amine oxide and especially coco dimethyl amino oxide. Amine oxide may have a linear or mid-branched alkyl moiety. Typical linear amine oxides include water-soluble amine oxides containing one R1 C8-18 alkyl moiety and 2 R2 and R3 moieties selected from the group consisting of C1-3 alkyl groups and C1-3 hydroxyalkyl groups. Preferably amine oxide is characterized by the formula R1-N(R2)(R3) O wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein.

The amine oxide further comprises two moieties, independently selected from a C1-3 alkyl, a C1-3 hydroxyalkyl group, or a polyethylene oxide group containing an average of from about 1 to about 3 ethylene oxide groups. Preferably the two moieties are selected from a C1-3 alkyl, more preferably both are selected as a C1 alkyl.

Zwitterionic Surfactant

Other suitable surfactants include betaines, such as alkyl betaines, alkylamidobetaine, amidazoliniumbetaine, sulfobetaine (INCI Sultaines) as well as the Phosphobetaine and preferably meets formula (I):

R1[CO—X (CH2)n]x-N+(R2)(R3)-(CH2)m-[CH(OH)-CH2]y-Y— (I)

wherein

R1 is a saturated or unsaturated C6-22 alkyl residue, preferably C8-18 alkyl residue, in particular a saturated C10-16 alkyl residue, for example a saturated C12-14 alkyl residue;

X is NH, NR4 with C1-4 Alkyl residue R4, O or S,

n a number from 1 to 10, preferably 2 to 5, in particular 3,

x 0 or 1, preferably 1,

R2, R3 are independently a C1-4 alkyl residue, potentially hydroxy substituted such as a hydroxyethyl, preferably a methyl.

m a number from 1 to 4, in particular 1, 2 or 3,

y 0 or 1 and

Y is COO, SO3, OPO(OR5)O or P(O)(OR5)O, whereby R5 is a hydrogen atom H or a C1-4 alkyl residue.

Preferred betaines are the alkyl betaines of the formula (Ia), the alkyl amido propyl betaine of the formula (Ib), the Sulfo betaines of the formula (Ic) and the Amido sulfobetaine of the formula (Id);

R1-N+(CH3)2-CH2COO— (Ia)

R1-CO—NH(CH2)3-N+(CH3)2-CH2COO— (Ib)

R1-N+(CH3)2-CH2CH(OH)CH2SO3- (Ic)

R1-CO—NH—(CH2)3-N+(CH3)2-CH2CH(OH)CH2SO3- (Id)

in which R11 as the same meaning as in formula I. Particularly preferred betaines are the Carbobetaine [wherein Y—═COO—], in particular the Carbobetaine of the formula (Ia) and (lb), more preferred are the Alkylamidobetaine of the formula (Ib).

Examples of suitable betaines and sulfobetaine are the following [designated in accordance with INCI]: Almondamidopropyl of betaines, Apricotam idopropyl betaines, Avocadamidopropyl of betaines, Babassuamidopropyl of betaines, Behenam idopropyl betaines, Behenyl of betaines, betaines, Canolam idopropyl betaines, Capryl/Capram idopropyl betaines, Carnitine, Cetyl of betaines, Cocamidoethyl of betaines, Cocam idopropyl betaines, Cocam idopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucam idopropyl Hydroxysultaine, Hydrogenated Tallow of betaines, Isostearam idopropyl betaines, Lauram idopropyl betaines, Lauryl of betaines, Lauryl Hydroxysultaine, Lauryl Sultaine, Milkam idopropyl betaines, Minkamidopropyl of betaines, Myristam idopropyl betaines, Myristyl of betaines, Oleam idopropyl betaines, Oleam idopropyl Hydroxysultaine, Oleyl of betaines, Olivamidopropyl of betaines, Palmam idopropyl betaines, Palm itam idopropyl betaines, Palmitoyl Carnitine, Palm Kernelam idopropyl betaines, Polytetrafluoroethylene Acetoxypropyl of betaines, Ricinoleam idopropyl betaines, Sesam idopropyl betaines, Soyam idopropyl betaines, Stearam idopropyl betaines, Stearyl of betaines, Tallowam idopropyl betaines, Tallowam idopropyl Hydroxysultaine, Tallow of betaines, Tallow Dihydroxyethyl of betaines, Undecylenam idopropyl betaines and Wheat Germam idopropyl betaines.

A preferred betaine is, for example, Cocoamidopropylbetaine.

Divalent Cation

When utilized in the composition of the invention, divalent cations such as calcium and magnesium ions, preferably magnesium ions, are preferably added as a hydroxide, chloride, acetate, sulfate, formate, oxide, lactate or nitrate salt to the compositions of the present invention, typically at an active level of from 0.01% to 1.5%, preferably from 0.015% to 1%, more preferably from 0.025% to 0.5%, by weight of the composition.

Chelant

The composition herein may optionally further comprise a chelant at a level of from 0.1% to 20%, preferably from 0.2% to 5%, more preferably from 0.2% to 3% by weight of the composition.

As commonly understood in the detergent field, chelation herein means the binding or complexation of a bi- or multi-dentate ligand. These ligands, which are often organic compounds, are called chelants, chelators, chelating agents, and/or sequestering agent. Chelating agents form multiple bonds with a single metal ion. Chelants, are chemicals that form soluble, complex molecules with certain metal ions, inactivating the ions so that they cannot normally react with other elements or ions to produce precipitates or scale, or destabilizing soils facilitating their removal accordingly. The ligand forms a chelate complex with the substrate. The term is reserved for complexes in which the metal ion is bound to two or more atoms of the chelant.

Suitable chelating agents can be selected from the group consisting of amino carboxylates, amino phosphonates, polyfunctionally-substituted aromatic chelating agents and mixtures thereof.

Amino carboxylates include ethylenediaminetetra-acetates, N-hydroxyethylethylenediaminetriacetates, nitrilo-triacetates, ethylenediamine tetraproprionates, triethylenetetraaminehexacetates, diethylenetriaminepentaacetates, and ethanoldiglycines, alkali metal, ammonium, and substituted ammonium salts therein and mixtures therein, as well as MGDA (methyl-glycine-diacetic acid), and salts and derivatives thereof and GLDA (glutamic-N,N-diacetic acid) and salts and derivatives thereof. GLDA (salts and derivatives thereof) is especially preferred according to the invention, with the tetrasodium salt thereof being especially preferred.

Other suitable chelants include amino acid based compound or a succinate based compound. The term “succinate based compound” and “succinic acid based compound” are used interchangeably herein. Other suitable chelants are described in U.S. Pat. No. 6,426,229. Particular suitable chelants include; for example, aspartic acid-N-monoacetic acid (ASMA), aspartic acid-N,N-diacetic acid (ASDA), aspartic acid-N-monopropionic acid (ASMP) , iminodisuccinic acid (IDS), Imino diacetic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), alanine-N,N-diacetic acid (ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA) , taurine-N,N-diacetic acid (TUDA) and sulfomethyl-N,N-diacetic acid (SMDA) and alkali metal salts or ammonium salts thereof. Also suitable is ethylenediamine disuccinate (“EDDS”), especially the [S,S] isomer. Furthermore, Hydroxyethyleneiminodiacetic acid, Hydroxyiminodisuccinic acid, Hydroxyethylene diaminetriacetic acid are also suitable.

Other chelants include homopolymers and copolymers of polycarboxylic acids and their partially or completely neutralized salts, monomeric polycarboxylic acids and hydroxycarboxylic acids and their salts. Preferred salts of the abovementioned compounds are the ammonium and/or alkali metal salts, i.e. the lithium, sodium, and potassium salts, and particularly preferred salts are the sodium salts.

Suitable polycarboxylic acids are acyclic, alicyclic, heterocyclic and aromatic carboxylic acids, in which case they contain at least two carboxyl groups which are in each case separated from one another by, preferably, no more than two carbon atoms. Polycarboxylates which comprise two carboxyl groups include, for example, water-soluble salts of, malonic acid, (ethylenedioxy) diacetic acid, maleic acid, diglycolic acid, tartaric acid, tartronic acid and fumaric acid. Polycarboxylates which contain three carboxyl groups include, for example, water-soluble citrate. Correspondingly, a suitable hydroxycarboxylic acid is, for example, citric acid. Another suitable polycarboxylic acid is the homopolymer of acrylic acid. Preferred are the polycarboxylates end capped with sulfonates.

Amino phosphonates are also suitable for use as chelating agents and include ethylenediaminetetrakis (methylenephosphonates) as DEQUEST. Preferred are these amino phosphonates that do not contain alkyl or alkenyl groups with more than about 6 carbon atoms.

Polyfunctionally-substituted aromatic chelating agents are also useful in the compositions herein. Preferred compounds of this type are dihydroxydisulfobenzenes such as 1,2-dihydroxy-3,5-disulfobenzene.

Further suitable polycarboxylates chelants for use herein include citric acid, lactic acid, acetic acid, succinic acid, formic acid; all preferably in the form of a water-soluble salt. Other suitable polycarboxylates are oxodisuccinates, carboxymethyloxysuccinate and mixtures of tartrate monosuccinic and tartrate disuccinic acid.

The most preferred chelants for use in the present invention are selected from the group consisting of diethylenetetraamine pentaacetic acid (DTPA), MGDA, GLDA, citrate and mixtures thereof.

The detergent composition herein may comprise a number of optional ingredients such as builders, conditioning polymers, cleaning polymers, surface modifying polymers, soil flocculating polymers, structurants, emollients, humectants, skin rejuvenating actives, enzymes, carboxylic acids, scrubbing particles, bleach and bleach activators, perfumes, malodor control agents, pigments, dyes, opacifiers, beads, pearlescent particles, microcapsules, antibacterial agents, enzymes, pH adjusters, preservatives, buffering means or water or any other dilutents or solvents compatible with the formulation.

Method of Washing

The second aspect of the invention is directed to a method of washing dishware with the composition of the present invention. Said method comprises the step of applying the composition, preferably in liquid form, onto the dishware surface, either directly or by means of a cleaning implement, i.e., in neat form.

By “in its neat form”, it is meant herein that said composition is not diluted in a full sink of water. The composition is applied directly onto the surface to be treated and/or onto a cleaning device or implement such as a dish cloth, a sponge or a dish brush without undergoing major dilution (immediately) prior to the application. The cleaning device or implement is preferably wet before or after the composition is delivered to it. Especially good grease removal has been found when the composition is used in neat form. The cleaning mechanism that takes place when compositions are used in neat form seems to be quite different to that taken place when compositions are used in diluted form.

There is also provided a method of washing dishware in full sink wherein a volume of water is provided, the cleaning composition is delivered to the volume of water and the dishware is immersed therein.

### EXAMPLES

The below examples illustrate the improved suds stability of a composition comprising the amine of the invention with decreasing pH of the wash solution versus a composition free of the amine of the invention. The examples also illustrate improved grease removal in direct application of compositions of the invention versus compositions free of the amine of the invention and the performance of a cleaning composition when part of the amine oxide co-surfactant is replaced by the amine of Formula (I).

Suds Stability Vs Wash Solution pH Test Method

This method measures the suds height of a composition wash solution (0.12 wt % product concentration) at different wash solution pHs (8.1, 6.6, 4.8). The suds height of the wash solution can be measured by employing a suds cylinder tester (SCT). The SCT has a set of 6 cylinders. Each cylinder is typically 30 cm long and 9 cm in diameter and may be independently rotated around its center point in vertical direction at a rate of 22 revolutions per minute (rpm). For executing the test, 6 cylinders are used, i.e. 2 internal replaces of 2 test products versus a reference. When solely testing 2 internal replicates of one test product versus a reference, the 2 empty cylinder(s) should always be filled with the same amount of water as the other cylinders to maintain the right balance.

Test Procedure
1. A water solution of a composition to be tested is prepared by dissolving 0.6 g+/−0.01 g of the composition into 500 ml water having water hardness of 7 dH and temperature of 20° C. Wash solutions are trimmed to the target wash solution pH (8.1+/−0.1) with NaOH or citric acid.
2. A scale is stuck on the external wall of each cylinder with 0 starting from the top surface of the cylinder bottom.
3. The SCT rotates at 22 rpm for a time period of 2 minutes, then the rotation is stopped and the suds height is measured as the height of the top layer of suds minus the water solution height.
4. The height of the top layer of suds should be the line which crosses the interface of air and dense suds and is vertical to the cylinder wall.
5. Scattered bubbles clinging to the interior surface of the cylinder wall shall not be counted in reading the suds height.
6. The average foam height of 2 replicates is reported.
7. After measuring the foam height of the rotated pH 8.1 wash solutions, the resulting wash solutions are immediately trimmed with citric acid to a wash solution pH of 6.6, and steps 3 to 6 are repeated.
8. After measuring the foam height of the rotated pH 6.6 wash solutions, the resulting wash solutions are further trimmed with citric acid to a wash solution pH of 4.8, and steps 3 to 6 are repeated.

Partial Replacement of the Co-Surfactant by the Amine of the Invention.

| % active by weight | | |
|---|---|---|
| of the composition | Reference A | Example A |
| C1213 alkyl ethoxy | 20.1 | 20.1 |
| (0.6) sulfate (AES) | | |
| C1214 dimethyl | 6.7 | 4.8 |
| amine oxide | | |
| Glucamine | — | 2.0 |
| Lutensol XP80 | 0.4 | 1.0 |
| NaCl | 0.7 | 0.7 |
| Polypropyleneglycol | 1.1 | 0.9 |
| (MW 2000) | | |
| Ethanol | 1.8 | 1.9 |
| pH (10% dilution in | 9.0 | 9.0 |
| demi water at 20° C.) - | | |
| with NaOH | | |
| Water and minors | To 100% | To 100% |
| (dye, perfume, | | |
| preservative) | | |

C1213 alkyl ethoxy (0.6) sulfate (AES): C12-13 alkyl ethoxy sulfate with an average degree of ethoxylation of 0.6
Glucamine: glucamine compound according to Formula (I), with R3 being 2-propylheptyl, R2 being methyl and n being 1
Lutensol XP80: Non-ionic surfactant available from BASF

Test Results

The table below shows the suds height at different wash solution pHs of a reference composition outside the scope of the invention not comprising the amine of the invention, and of a composition inside the scope of the invention comprising an amine according to the invention, wherein the amine of the invention partially replaced the co-surfactant. It is clear from the data that the amine of the invention helps sustaining the suds when the wash solution pH decreases.

| Foam height | pH 8.1 | pH 6.6 | pH 4.8 |
|---|---|---|---|
| Reference | 81.7 mm | 74.0 mm | 9.7 mm |
| Example A | 78.5 mm | 83.5 mm | 59.0 mm |

Replacement of the Co-Surfactant by the Amine of the Invention

Test Products

| % active by weight | | |
|---|---|---|
| of the composition | Reference B | Example B |
| C1213 alkyl ethoxy | 20.4 | 20.4 |
| (0.6) sulfate (AES) | | |
| C1214 dimethyl | 6.8 | — |
| amine oxide | | |
| Glucamine | — | 6.8 |
| NaCl | 0.7 | 0.7 |
| Polypropyleneglycol | 0.9 | 0.9 |
| (MW 2000) | | |
| Ethanol | 1.9 | 1.9 |
| pH (10% dilution in | 9.0 | 9.0 |
| demi water at 20° C.) - | | |
| with NaOH | | |
| Water and minors | To 100% | To 100% |
| (dye, perfume, | | |
| preservative) | | |

C1213 alkyl ethoxy (0.6) sulfate (AES): C12-13 alkyl ethoxy sulfate with an average degree of ethoxylation of 0.6
Glucamine: glucamine compound according to Formula (I), with R3 being 2-propylheptyl, R2 being methyl and n being 1
Lutensol XP80: Non-ionic surfactant available from BASF

Test Results

The table below shows the suds height at different wash solution pHs of a reference composition outside the scope of the invention not comprising the amine of the invention, and of a composition inside the scope of the invention comprising an amine according to the invention. The co-surfactant is replaced by the amine of the invention. It is clear from the data that the amine of the invention helps sustaining the suds when the wash solution pH decreases.

| Foam height | pH 8.1 | pH 6.6 | pH 4.8 |
|---|---|---|---|
| Reference | 79.7 mm | 69.0 mm | 19.3 mm |
| Example A | 68.0 mm | 75.7 mm | 82.7 mm |

Crystalline Grease Cleaning Test Method

A polypropylene nonwoven substrate (SMS 60 g/sm—supplier: Avgol Nonwovens LTD) of dimensions 4.5 cm×4.5 cm is soiled with 175-200 mg of Beef Fat (composition: see table below) colored with 0.05% EGN Oil Red dye (supplier: Sigma-Aldrich). Soiled substrate is put at 21° C./35% RH for minimum 48 and max 120 hours to dry. After drying, the initial soil level is measured via weighing of the soiled substrate versus the weight of the unsoiled substrate.

Beef Fat Composition:

| Ingredient | Supplier | [%, as is] |
|---|---|---|
| Refined Rendered Edible Beef | Bunge North America | 99.419 |
| Tallow | Corporate Headquarters | |
| | 11720 Borman Drive | |
| | St. Louis, MO 63146 | |
| Oleic Acid, 90% (Techn) | Aldrich | 0.274 |
| Palmitic Acid, 99+% | VWR | 0.207 |
| Stearic Acid, 99+% (Gold Label) | Aldrich | 0.101 |
| | Total: | 100 |

The grease cleaning performance is tested with a LaunderO-meter (Washtec device—supplier: Roaches International LTD). Three soiled substrates as internal replicates are put in a LaunderO-meter jar with 200 g of wash solution at desired water hardness (2 dH-15 dH) and product concentration (5%), together with 4 marbles for extra abrasion. Washing is done for 5 min at 35° C. followed by a 5 minutes rinse with 200 g of water at desired water hardness (2 dH-15 dH, i.e. same as wash water hardness) and room temperature.

After washing and drying (minimum 48 hours at 21° C./35% RH), the remaining soil level is measured by weighing and % grease removal is calculated as follows: ((soil weight before washing−soil weight after washing)/soil weight before washing)×100%. The average % grease removal of the 3 internal replicates is reported as a grease cleaning index versus a chosen reference product in the test according to formula 1.

grease cleaning index test product=(% grease removal test product/% grease removal reference product)*100. Formula 1:

Resulting grease cleaning indexes are reported. The higher the grease cleaning index the higher the grease cleaning potential of the test product.

Test Products

| % active by weight | Reference | Example | Example | Example | Example | Example |
|---|---|---|---|---|---|---|
| of the composition | A | B | C | D | E | F |
| C1213 alkyl | 22.82 | 22.82 | 22.82 | 22.82 | 22.82 | 22.82 |
| ethoxy (0.6) sulfate | | | | | | |
| (AES) | | | | | | |
| C1214 dimethyl | 4.56 | 4.56 | 4.56 | 4.56 | 4.56 | 4.56 |
| amine oxide | | | | | | |
| Amine 1 | — | 2.0 | — | — | — | — |
| Amine 2 | — | — | 2.0 | — | — | — |
| Amine 3 | — | — | — | 2.0 | — | — |
| Amine 4 | — | — | — | — | 2.0 | — |
| Amine 5 | — | — | — | — | — | 2.0 |
| Lutensol XP80 | 0.41 | 0.41 | 0.41 | 0.41 | 0.41 | 0.41 |
| NaCl | 0.75 | 0.75 | 0.75 | 0.75 | 0.75 | 0.75 |
| Polypropyleneglycol | 1.00 | 1.00 | 1.00 | 1.00 | 1.00 | 1.00 |
| (MW 2000) | | | | | | |
| Ethanol | 2.00 | 2.00 | 2.00 | 2.00 | 2.00 | 2.00 |
| pH (10% dilution | 9.0 | 9.0 | 9.0 | 9.0 | 9.0 | 9.0 |
| in demi water at | | | | | | |
| 20° C.)—with | | | | | | |
| NaOH | | | | | | |
| Water and minors | To 100% | To 100% | To 100% | To 100% | To 100% | To 100% |
| (dye, perfume, | | | | | | |
| preservative) | | | | | | |

| Amine definition | Amine 1 | Amine 2 | Amine 3 | Amine 4 | Amine 5 |
|---|---|---|---|---|---|
| 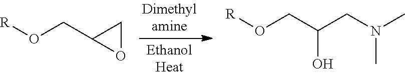 | R = hexyl | R = octyl | R = 2- ethylhexyl | R = n-decyl | R = n-dodecyl/ n-tetradecyl |

The amine of formula 5 was prepared by reacting dodecanol/tetradecanol derived aylkyl glycidyl ether (2-((n-dodecyl/n-tetradecyl)oxy)oxirane) with dimethylamine in water in the presence of ethanol as the solvent. The reactants were stirred in a pressure vessel at 100° C. for a total of 20 hours followed by cooling to room temperature and transferring to a separation funnel. Hexanes were added followed by removal of the aqueous layer and drying of the organic layer with sodium sulphate. Solvent was removed under vacuum to yield the amine of formula 5 (1-(dimethylamino)-3-(dodecyl/n-tetradecyl oxy)propan-2-ol). The other amines were prepared in a similar fashion.

Test Results

The table below shows that a composition according to the invention provides better grease cleaning than a similar composition without the amine of the invention.

| | Example | Example | Example | Example | Example |
|---|---|---|---|---|---|
| Ref. A = 100 | B | C | D | E | F |
| Cleaning | 150/— | 145/205 | 155/175 | 145/155 | 115/140 |
| index | | | | | |
| (15 dH/ | | | | | |
| 2 dH) | | | | | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A hand dishwashing cleaning composition comprising a surfactant system and an amine of Formula (I):
R1-N-(R2)(CH2CHOH(CH2O)nR3) (1)
wherein R1 and R2 are independently selected from hydrogen, cyclic or acyclic, linear or branched C1 to C10 alkyl, C1 to C10 hydroxyalkyl, polyhydroxyhydrocarbyl and polyalkoxy of formula (R4-O)xH with R4 being C1-C4 and x=about 1 to about 15;
n is 0 or 1; and
R3 is a C6 to C30 hydrocarbyl.

2. The cleaning composition according to claim 1 wherein R1 is a polyhydroxyhydrocarbyl derived from a sugar selected from the group consisting of a monosaccharide such as glucose, xylose, fructose or sorbitol; a disaccharide such as maltose or sucrose; and a higher oligosaccharide.

3. The cleaning composition according to claim 1 wherein R1 is a polyhydroxyhydrocarbyl derived from glucose.

4. The cleaning composition according to claim 1 wherein R1 is hydrogen or methyl.

5. The cleaning composition according to claim 1 wherein R2 is hydrogen or methyl.

6. The cleaning composition according to claim 1 wherein R3 is a C6 to C10 alkyl.

7. The cleaning composition according to claim 6 wherein the C6 to C10 alkyl is selected from the group consisting of hexyl, octyl, decyl and mixtures thereof.

8. The cleaning composition according to claim 1 wherein R1 is glucose, R2 is methyl and R3 is hexyl, octyl or decyl.

9. The cleaning composition according to claim 1 comprising from about 0.1 to about 15% by weight of the composition of the amine.

10. The composition according to claim 1 wherein the surfactant system comprises an anionic surfactant and a co-surfactant selected from the group consisting of amphoteric surfactant, zwitterionic surfactant and mixtures thereof.

11. The composition according to claim 10 wherein the anionic surfactant is selected from the group consisting of alkyl sulfate, alkyl alkoxy sulfate and mixtures thereof.

12. The composition according to claim 11 wherein the alkyl alkoxy sulfate is an alkyl ethoxy sulfate.

13. The composition according to claim 1 wherein the co-surfactant is an amine oxide surfactant.

14. A method of manually washing dishware comprising the step of delivering a composition according to claim 1 directly onto the dishware or onto a cleaning implement and using the cleaning implement to clean the dishware.

15. A method of manually washing dishware comprising the step of: delivering a composition according to claim 1 to a volume of water to form a wash solution and immersing the dishware in the solution.

16. A wash solution for hand dishwashing comprising acidifying soil and a cleaning composition, wherein the cleaning composition comprises an amine of Formula (I):
R1-N-(R2)(CH2CHOH(CH2O)nR3) (1)
wherein R1 and R2 are independently selected from hydrogen, cyclic or acyclic, linear or branched C1 to C10 alkyl, C1 to C10 hydroxyalkyl, polyhydroxyhydrocarbyl and polyalkoxy of formula (R4-O)xH with R4 being C1-C4 and x=1 to 15;
n is about 0 or about 1; and
R3 is a C6 to C30 hydrocarbyl; and
a surfactant system comprising an anionic surfactant selected from the group consisting of a sulfate, sulfonate anionic surfactants, and mixtures thereof; and a co-surfactant selected from the group consisting of amphoteric surfactant, zwitterionic surfactant and mixtures thereof; wherein the pH of the wash solution is above about 7.

17. The wash solution according to claim 16 wherein the sulphate or sulfonate anionic surfactants are selected from the consisting of alkyl sulfate, alkyl alkoxy sulfate and mixtures thereof.

18. The wash solution according to claim 17 wherein the alkyl alkoxy sulfate is an alkyl ethoxy sulphate.

19. The wash solution according to claim 16 wherein the pH of the wash solution is between about 7 and about 9.
